(19) United States
(12) Patent Application Publication
(10) Pub. No.: US 2025/0239886 A1
(43) Pub. Date: Jul. 24, 2025

(54) ADJUSTABLE UNDERCOUNTER MOUNT FOR WIRELESS POWER TRANSMITTER

(71) Applicant: Midea Group Co., Ltd., Foshan (CN)

(72) Inventors: Daniel J. Trice, Louisville, KY (US); John Kenneth Hooker, Louisville, KY (US)

(73) Assignee: Midea Group Co., Ltd., Foshan (CN)

(21) Appl. No.: 18/416,402

(22) Filed: Jan. 18, 2024

(51) Int. Cl. H02J 50/00; A47B 77/02; H02J 50/10

(52) U.S. Cl. CPC H02J 50/005; A47B 77/022; H02J 50/10; A47B 2200/008

(57) ABSTRACT

An undercounter wireless power system utilizes an adjustable undercounter mount capable of supporting a wireless power transmitter housed within a tray underneath a countertop supported by a base cabinet. In some instances, the adjustable undercounter mount includes one or more adjustable rails having adjustable lengths and including opposing ends configured to be secured to opposing support structures of the base cabinet and having adjustable lengths, and in some instances, the adjustable undercounter mount includes one or more mounting brackets including flanges that engage a mounting lip that extends at least partially around a periphery of the tray.

### BACKGROUND

A wide variety of kitchen appliances are commonly used in single-family and multi-family residential applications. Many of these appliances, e.g., dishwashers, wine coolers, refrigerators, laundry washing machines, ovens, ranges, cooktops, etc., are installed in a “built-in” fashion such as under a countertop, within a cut-out formed in the countertop, or in a designated opening in the arrangement of kitchen cabinets. Built-In appliances are often hard-wired into a household electrical circuit or are plugged in to a dedicated electrical outlet that is generally hidden from view when the appliance is in its installed location.

Many consumers, however, also rely on various smaller kitchen appliances to perform more specific tasks, including, for example, microwave ovens, rice cookers, blenders, mixers, food processors, toasters, air fryers, pressure cookers, coffee makers, espresso machines, etc. While sometimes these appliances are stored on the countertop when not in use, in other instances these appliances may be stored in the cabinets or elsewhere and brought out when needed. To power such devices, many kitchens include electrical outlets on the wall between the upper cabinets and the countertop, which is often referred to as a backsplash, so that such appliances may be plugged in when needed. The power cords used by such appliances, however, can be cumbersome and unsightly, both during use and in storage.

More recently, it has been proposed to use wireless power for smaller kitchen appliances, e.g., based upon the Ki Kitchen Cordless Standard developed by the Wireless Power Consortium. Rather than relying on a power cord plugged into an electrical outlet, a wirelessly-powered appliance includes a wireless power receiver that is oriented on the bottom of the appliance to receive power wirelessly from a wireless power transmitter that is positioned underneath a support surface (e.g., a cooktop, a countertop or table) when the appliance is positioned directly over the wireless power transmitter. Undercounter wireless power transmitters are particularly desirable, as they leave a cooktop free for cooking, and are otherwise generally hidden from view and otherwise leave the countertop available for other tasks when not in use.

Undercounter wireless power transmitters, however, present a number of installation and mounting challenges. The amount of vertical separation between a wireless power transmitter and the wireless power receiver of a wirelessly powered appliance is generally limited, and much of the vertical separation is occupied by the countertop itself. The amount of space underneath the countertop, and above the interior space within a base cabinet that is used to store items, is also generally limited due to a general desire to maximize the amount of space that is available for storage in the cabinet. Furthermore, base cabinets are generally not uniform in construction or dimensions, and can vary considerably in terms of width as well as the types of support structures that may be present near the interface with the countertop. In addition, while it may be possible in some installation scenarios (e.g., new construction) to install a wireless power transmitter prior to installing a countertop, in other installation scenarios (e.g., retrofit installations), the countertop may already be secured in place on top of the base cabinet, such that installation must be performed from underneath and relying on access to the underside of the countertop through the front of the cabinet itself.

A substantial need therefore exists in the art for a manner of mounting a wireless power transmitter underneath a countertop that is simple, secure, and adaptable to different installation scenarios.

### SUMMARY

The herein-described embodiments address these and other problems associated with the art by providing an undercounter wireless power system that utilizes an adjustable undercounter mount capable of supporting a wireless power transmitter housed within a tray underneath a countertop supported by a base cabinet. In some instances, the adjustable undercounter mount includes one or more adjustable rails having adjustable lengths and including opposing ends configured to be secured to opposing support structures of the base cabinet and having adjustable lengths, and in some instances, the adjustable undercounter mount includes one or more mounting brackets including flanges that engage a mounting lip that extends at least partially around a periphery of the tray.

Therefore, consistent with one aspect of the invention, an undercounter wireless power system may include a wireless power transmitter, a tray housing the wireless power transmitter, and an adjustable rail configured to support the tray proximate an underside of a countertop supported by a base cabinet, the adjustable rail including first and second opposing ends respectively configured to be secured to first and second opposing support structures of the base cabinet, the adjustable rail having an adjustable length to position the first and second opposing ends thereof proximate the first and second opposing support structures.

In some embodiments, the adjustable rail is configured to extend between a front side and a rear side of the base cabinet to support the tray proximate the underside of the countertop through a front-to-rear mounting to the base cabinet. Also, in some embodiments, the adjustable rail is configured to extend between a left side and a right side of the base cabinet to support the tray proximate the underside of the countertop through a left-to-right mounting to the base cabinet. Further, in some embodiments, the adjustable rail is configured to support the tray at an adjustable position between the first and second opposing support structures. In some embodiments, the adjustable rail is configured to support the tray proximate the underside of the countertop with no direct fastening of the tray or the adjustable rail to the countertop.

In addition, in some embodiments, the adjustable rail is a first adjustable rail, and the undercounter wireless power system further includes a second adjustable rail configured to support the tray proximate an opposite side of the tray from the first adjustable rail, the second adjustable rail including first and second opposing ends respectively configured to be secured to the first and second opposing support structures of the base cabinet, and the second adjustable rail having an adjustable length to position the first and second opposing ends thereof proximate the first and second opposing support structures. Some embodiments may also include a mounting bracket secured to the adjustable rail, and the adjustable rail supports the tray using the mounting bracket. In some embodiments, the tray includes a mounting lip disposed proximate a periphery thereof, and the mounting bracket includes a flange that engages the mounting lip of the tray. In addition, in some embodiments, the flange is resilient to clamp the tray against the underside of the countertop. Moreover, in some embodiments, the mounting bracket includes one or more set screws extending through the flange of the mounting bracket to such that the flange engages the mounting lip of the tray through the one or more set screws to thereby clamp the tray against the underside of the countertop.

In some embodiments, the mounting lip includes left, right, front, and rear portions respectively configured to extend toward left, right, front, and rear sides of the base cabinet, and the flange of the mounting bracket is configured to engage the mounting lip of the tray at any one of the left, right, front, and rear portions thereof to support both left-to-right and front-to-rear mounting to the base cabinet. Moreover, in some embodiments, the mounting bracket is removably secured to the adjustable rail and is configured to be independently secured to a support structure of a different base cabinet when separated from the adjustable rail.

In some embodiments, the adjustable rail includes first and second rail members, the first rail member is sized and configured to slide within the second rail member, at least one of the first and second rail members includes a slot extending along at least a portion of the length thereof, and the mounting bracket is removably secured to the adjustable rail using at least one nut and bolt assembly that extends through the slot to fix the length of the adjustable rail. In addition, in some embodiments, the at least one nut and bolt assembly further extends through the mounting bracket to secure the mounting bracket to the adjustable rail.

Some embodiments may also include a power electronics enclosure physically separated from the tray and configured to be secured to a wall of the base cabinet, a power supply disposed in the power electronics enclosure and configured to generate a power signal to drive the wireless power transmitter, and at least one power cable extending between the power electronics enclosure and the tray to communicate the power signal to the wireless power transmitter. Some embodiments may further include a near field communication (NFC) antenna and a controller disposed in the tray and electrically coupled to the NFC antenna to communicate with a wirelessly powered device positioned on the countertop proximate the wireless power transmitter, the controller further electrically coupled to the power supply through at least one control cable extending between the tray and the power electronics enclosure to control the power supply to selectively supply power to the wirelessly powered device through the wireless power transmitter.

Consistent with another aspect of the invention, an undercounter wireless power system may include a wireless power transmitter, a tray housing the wireless power transmitter, the tray including a mounting lip disposed proximate a periphery thereof, and a mounting bracket configured to be secured to a support structure of a base cabinet, the mounting bracket including a flange configured to engage the mounting lip of the tray when secured to the support structure of the base cabinet and thereby support the tray proximate an underside of a countertop supported by the base cabinet.

In addition, some embodiments may further include an adjustable rail removably securable to the mounting bracket and including first and second opposing ends respectively configured to be secured to first and second opposing support structures of the base cabinet, the adjustable rail having an adjustable length to position the first and second opposing ends thereof proximate the first and second opposing support structures. In some embodiments, the mounting lip includes left, right, front, and rear portions respectively configured to extend toward left, right, front, and rear sides of the base cabinet, and the flange of the mounting bracket is configured to engage the mounting lip of the tray at any one of the left, right, front, and rear portions thereof to support both left-to-right and front-to-rear mounting to the base cabinet.

Consistent with another aspect of the invention, an adjustable undercounter mount for an undercounter wireless power system of a type including a wireless power transmitter and a tray housing the wireless power transmitter may include a mounting bracket configured to support the tray proximate an underside of a countertop supported by a base cabinet, and an adjustable rail removably secured to the mounting bracket and including first and second opposing ends respectively configured to be secured to first and second opposing support structures of the base cabinet, the adjustable rail having an adjustable length to position the first and second opposing ends thereof proximate the first and second opposing support structures, and the mounting bracket configured to be independently secured to a support structure of a different base cabinet when separated from the adjustable rail.

Other embodiments may include various methods for making and/or using any of the aforementioned constructions and/or various apparatuses for performing any the aforementioned operations.

These and other advantages and features, which characterize the invention, are set forth in the claims annexed hereto and forming a further part hereof. However, for a better understanding of the invention, and of the advantages and objectives attained through its use, reference should be made to the Drawings, and to the accompanying descriptive matter, in which there is described example embodiments of the invention. This summary is merely provided to introduce a selection of concepts that are further described below in the detailed description, and is not intended to identify key or essential features of the claimed subject matter, nor is it intended to be used as an aid in limiting the scope of the claimed subject matter.

### BRIEF DESCRIPTION OF THE DRAWINGS

FIG. 1 is a perspective view of a room incorporating an undercounter wireless power system and an adjustable undercounter mount consistent with some embodiments of the invention.

FIG. 2 is a top plan view of the countertop and wireless power system of FIG. 1.

FIG. 3 is a block diagram of an example control system for the wireless power system and wirelessly powered appliance of FIG. 1.

FIG. 4 is a perspective view of a base cabinet with an undercounter wireless power system mounted thereto using an adjustable undercounter mount consistent with some embodiments of the invention.

FIG. 5 is a perspective view of the base cabinet of FIG. 4, with portions thereof cut away.

FIG. 6 is an exploded perspective view of portions of the undercounter wireless power system and adjustable undercounter mount of FIGS. 4-5.

FIG. 7 is a cross-sectional view taken through lines 7-7 of FIG. 5.

FIG. 8 is a cross-sectional view taken through lines 8-8 of FIG. 5.

FIG. 9 is a cross-sectional view of the undercounter wireless power system and adjustable undercounter mount of FIGS. 4-5, alternatively secured to a side support member of a base cabinet.

FIG. 10 is a cross-sectional view of another undercounter wireless power system and adjustable undercounter mount consistent with some embodiments of the invention.

FIG. 11 is a top plan view of the undercounter wireless power system and adjustable undercounter mount of FIGS. 4-5, alternatively secured to a base cabinet in a left-to-right mounting configuration.

FIG. 12 is a top plan view of the undercounter wireless power system and adjustable undercounter mount of FIGS. 4-5, alternatively secured in a left-to-right mounting configuration to a front stretcher and left and right side walls of a base cabinet.

### DETAILED DESCRIPTION

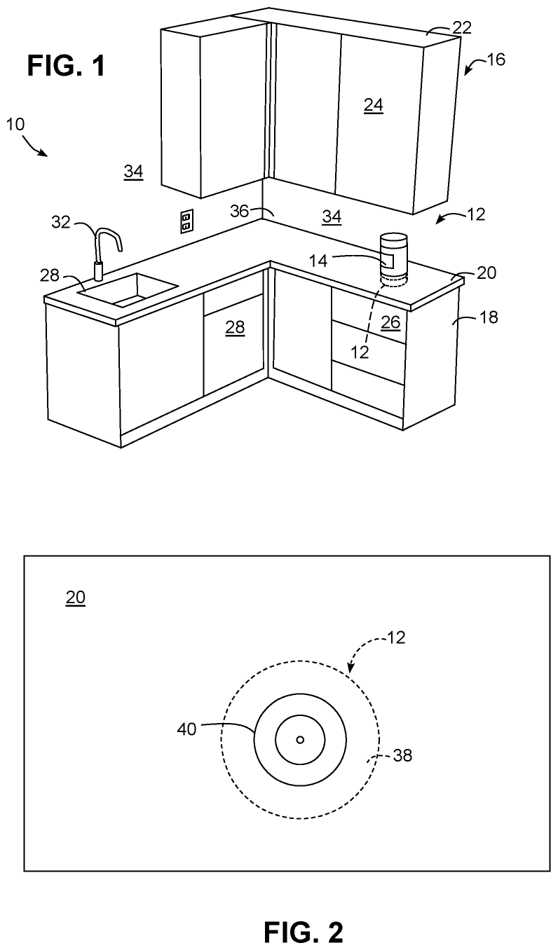

Turning now to the drawings, wherein like numbers denote like parts throughout the several views, FIG. 1 illustrates an example room (e.g., a kitchen) 10 within which is installed an undercounter wireless power system 12 suitable for powering one or more wirelessly powered appliances, e.g., a wirelessly powered appliance 14 implemented as a pressure cooker. Room 10 includes a built-in cabinet system 16, which includes one or more base cabinets 18 that support a countertop 20 and one or more upper or wall cabinets 22 that are positioned over countertop 20. Cabinets 18, 22 may include doors, e.g., door 24, in some instances, or may include drawers (e.g., drawer 26) or open shelves, and it will be appreciated that in some instances, various built-in appliances (e.g., dishwasher 28) may also be mounted or positioned within built-in cabinet system 16 (other appliances include, but are not limited to, refrigerators, ovens, ranges, cooktops, laundry washing machines, dryers, etc.) One or more sinks 30 may also be disposed on countertop 20 and may be supplied with water by a faucet 32.

Cabinets 18, 22 are generally secured along one or more walls 34 in room 10, with wall cabinets 22 generally mounted to walls 34 and positioned above counter height, e.g., above countertop 20, which is supported by base cabinets 18. In the United States, for example, the countertop may be at a height (from the floor) of approximately 36 inches with the wall cabinets at a height (from the floor) of approximately 54 inches, such that the wall area between the countertop and the bottom of the wall cabinets, referred to herein as a backsplash 36, has a height (from the countertop to the bottom of the wall cabinets) of approximately 18 inches. Base cabinets 18 may or may not be secured to walls 34, but are otherwise generally floor standing such that their load is predominantly borne by the floor rather than a wall, which is generally the case for wall cabinets 22.

It will be appreciated that other countertop, wall cabinet, and backsplash heights may be used in other embodiments. It will also be appreciated that room 10 may be any suitable indoor or outdoor living or working space within which it may be desirable to use a wirelessly powered appliance, including rooms lacking any built-in cabinets or countertops. Example types of suitable rooms include a kitchen, bar, entertainment area, bedroom, office area, retail establishment, etc. In some embodiments, room 10 may even be disposed within a boat or recreational vehicle.

With additional reference to FIG. 2, wireless power system 12 may include a wireless power transmitter 38 mounted underneath countertop 20. Furthermore, it will be appreciated that, due to the opaque nature of countertop 20, it may not be readily apparent to a user where exactly the wireless power transmitter 38 is located, so it may be desirable to place some indicator 40 on the top surface of countertop 20 to assist a user in properly positioning a wirelessly powered appliance over the wireless power transmitter. Indicator 40 may be formed on countertop 20 in a number of manners, e.g., via adhesives (such as where the indicator is a sticker), paint, etching, fasteners, etc. Furthermore, indicator 40 may take various forms, e.g., concentric rings, cross-hairs, or even a simple point or dot. The size of the indicator may also vary in different embodiments, and in some embodiments, may be large enough such that the outer perimeter of the indicator is still visible when the wirelessly powered appliance is positioned over the wireless power transmitter. An indicator may also be projected in some embodiments, e.g., downwardly from a light source positioned underneath a wall cabinet 22.

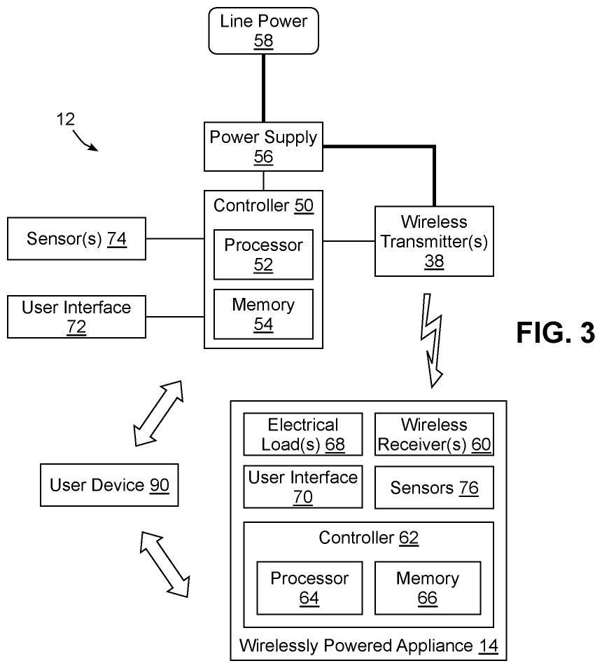

Now turning to FIG. 3, wireless power system 12 may be under the control of a controller 50 that receives inputs from a number of components and drives a number of components in response thereto. Controller 50 may, for example, include one or more processors 52 and one or more memories 54 within which may be stored program code for execution by the one or more processors. The memories may be embedded in controller 50, but may also be considered to include volatile and/or non-volatile memories, cache memories, flash memories, programmable read-only memories, read-only memories, etc., as well as memory storage physically located elsewhere from controller 50, e.g., in a mass storage device or on a remote computer interfaced with controller 50. Controller 50 may also be implemented at least in part using discrete circuit logic, as will be appreciated by those of ordinary skill having the benefit of the instant disclosure.

As shown in FIG. 3, controller 50 may be powered by a power supply 56, which is supplied with line power 58 (e.g., 120-240 VAC, as may be provided by a residential electrical circuit), via an electrical outlet and plug, or alternatively, a hard-wired connection. Power supply 56 also drives wireless power transmitter 38, e.g., using a high power, high frequency signal suitable for inductive power transfer to a wireless power receiver. Controller 50 may control wireless power transmitter 38 (in some instances by controlling power supply 56) to selectively activate/deactivate the wireless power transmitter, to regulate the power output of the wireless power transmitter, to communicate data to and/or receive data from wirelessly powered appliance 14, etc. In the illustrated embodiment, wireless power transmitter 38 is compatible with the Ki Kitchen Cordless Standard developed by the Wireless Power Consortium, although other wireless power or charging standards may be used in other embodiments, including, for example, the Qi Wireless Charging Standard also developed by the Wireless Power Consortium. It will be appreciated that the control over wireless power transmitter 38 by controller 50 to emit a wireless power signal would be well within the abilities of those of ordinary skill having the benefit of the instant disclosure. In addition, in some instances multiple wireless transmitters may be used, e.g., a high power wireless power transmitter used to power the primary electrical loads of a wirelessly powered appliance, and a lower power wireless transmitter (e.g., a Near Field Communication (NFC) transmitter used to communicate data with a wirelessly powered appliance).

Wirelessly powered appliance 14 may include one or more wireless power receivers 60 that, when positioned proximate wireless power transmitter 38, receives a wireless power signal to supply power to the wirelessly powered appliance. Wirelessly powered appliance 14 may also include a controller 62 to operate wireless power receiver 60, as well as to perform other appliance-related functions. Controller 62 may include one or more processors 64 and one or more memories 66 similar to processors and memories 52, 54 of wireless power system 12. Power received by wireless power receiver 60 may be used to also power one or more electrical loads 68, e.g., motors, heating elements, displays, etc., as well as controller 62 itself.

In some embodiments, wirelessly powered appliance 14 may include a user interface 70 to operate the appliance, and, beyond the supply of wireless power, may operate completely independently from wireless power system 12. In other embodiments, however, wireless power system 12 may be functionally integrated with wirelessly powered appliance 14, e.g., such that a user interface 72 of wireless power system 12 is used to display information received from wirelessly powered appliance 14 and/or other status information (e.g., via one or more status lights). Communication between wireless power system 12 and wirelessly powered appliance 14 may be over a Near Field Communication (NFC) wireless link as supported by the Ki standard, or via a separate wired or wireless network.

It may also be desirable to provide one or more sensors 74, 76 for sensing various states associated with wireless power system 12 and/or wirelessly powered appliance 14. For example, one or more temperature sensors and/or current, voltage, induction, and/or power sensors may be used in some embodiments to monitor wireless power transfer and prevent overheating. Various sensors associated with the primary functions of wirelessly powered appliance 14 may also be included. Other suitable sensors will be appreciated by those of ordinary skill having the benefit of the instant disclosure.

It should be appreciated that wireless power is distinguished from wireless charging in the context of the present disclosure, as while a wireless power system may in some instances provide power to charge a battery of an appliance or other electronic device wirelessly coupled to the wireless power system, such a use is secondary to providing wireless power to operate the appliance, i.e., to provide the primary power supply to the appliance during its active use. As such, a wirelessly powered appliance in many instances may not include any battery or other power storage element capable of independently providing sufficient power to operate the wirelessly powered appliance, such that the wirelessly powered appliance is effectively inoperable unless coupled to a wireless or wired power source (since some wirelessly powered appliances may also be capable of being plugged in). For many wirelessly powered appliances used for cooking for example, high power draw electrical loads such as electric motors and/or heating elements may be used, and to the extent any power storage element is present on such a wirelessly powered appliance, it is incapable of sufficiently powering such high power draw electrical loads, such that the wirelessly powered appliance is principally powered through a wireless power system as described herein.

In some embodiments, each controller 50, 62 may operate under the control of an operating system and may execute or otherwise rely upon various computer software applications, components, programs, objects, modules, data structures, etc. In addition, each controller 50, 62 may also incorporate hardware logic to implement some or all of the functionality disclosed herein. Further, in some embodiments, the sequences of operations performed by each controller 50, 62 to implement the embodiments disclosed herein may be implemented using program code including one or more instructions that are resident at various times in various memory and storage devices, and that, when read and executed by one or more hardware-based processors, perform the operations embodying desired functionality. Moreover, in some embodiments, such program code may be distributed as a program product in a variety of forms, and that the invention applies equally regardless of the particular type of computer readable media used to actually carry out the distribution, including, for example, non-transitory computer readable storage media. In addition, it will be appreciated that the various operations described herein may be combined, split, reordered, reversed, varied, omitted, parallelized and/or supplemented with other techniques known in the art, and therefore, the invention is not limited to the particular sequences of operations described herein.

In addition, in some embodiments, at least a portion of the functionality of wireless power system 12 and/or wirelessly powered appliance 14 may be implemented remote therefrom, e.g., using a user device 90, such as a mobile device, that is in communication with system 12 and/or appliance 14. As such, a controller discussed herein may also be incorporated partially or completely within a user device in some embodiments.

Numerous variations and modifications to wireless power system 12 and wirelessly powered appliance 14 illustrated in FIGS. 1-3 will be apparent to one of ordinary skill in the art, as will become apparent from the description below. Therefore, the invention is not limited to the specific implementations discussed herein.

### Adjustable Undercounter Mount for Wireless Power Transmitter

Undercounter wireless power transmitters present a number of installation and mounting challenges. It is generally desirable, for example, for a wireless power transmitter to be hidden for aesthetic purposes. In addition, it is generally desirable to avoid modifications to the countertop itself, given that many countertops are formed of natural or synthetic materials that are not easily altered, particularly in retrofit applications where the countertop is already installed on top of a base cabinet. Wireless power standards such as the Ki standard, however, often limit the amount of vertical separation between a wireless power transmitter and a wireless power receiver, such that is it generally desirable to locate a wireless transmitter as close as possible to the underside of a counter. The Ki standard, for example, is designed such that optimal power transfer generally occurs with a separation of about 40 mm between a wireless power transmitter and a wireless power receiver, and considering that the standard countertop thickness is about 30 mm, and that a wireless power receiver may be separated some distance from the bottom of a wirelessly powered appliance, a wireless power transmitter generally should be located no more than 10 mm (and preferably less) from the underside of a countertop.

Considering also that the base cabinet that supports a countertop has a primary function of storing utensils and other items, it is also desirable to minimize the amount of space occupied by an undercounter wireless power transmitter. Many base cabinets, for example, include an open-top drawer located at the top of the cabinet, and some consumers may be prone to overfilling these drawers from time to time, such that the more a wireless power transmitter projects downwardly into the space above an open-top drawer, the greater the risk is that items stored in the drawer may catch on the wireless power transmitter, as well as that the drawer may be prevented from opening.

Base cabinets are also not uniform in construction or dimensions. While overall base cabinet depth is generally standardized at 21 or 24 inches, base cabinet widths can vary considerably, e.g., generally with widths varying between about 12 and 42 inches in 3 inch increments. Moreover, various support structures may be incorporated into a base cabinet to support a countertop and/or to otherwise stabilize the base cabinet, and it is not uncommon to find horizontally-oriented supports located proximate the top of one or more of the front, rear and sides of a base cabinet.

It should also be understood that wireless power transmitters may be installed before installation of a countertop on a base cabinet (e.g., in new construction or in connection with installing in new cabinets) or after installation of a countertop on a base cabinet (e.g., when installing in existing cabinets). These different installations, however, present different challenges, as installation before installation of a countertop must accommodate placement of the countertop on top of the wireless power transmitter, and installation after installation of a countertop may be complicated by the difficulties associated with accessing the underside of the countertop through the existing base cabinet structure.

Embodiments consistent with the invention, on the other hand, may utilize an adjustable undercounter mount to support a wireless power transmitter of a wireless power system underneath a countertop supported by a base cabinet, and to do so in a manner that is space efficient and accommodates a wide variety of cabinet dimensions and constructions.

In some embodiments, for example, an undercounter wireless power system may include a wireless power transmitter and an adjustable undercounter mount that supports the wireless power transmitter proximate an underside of a countertop supported by a base cabinet. The adjustable undercounter mount may include a tray that houses the wireless power transmitter, and in some instances, the tray may include a mounting lip disposed proximate a periphery thereof, which in some embodiments may extend around at least a portion of the periphery of the tray. The adjustable undercounter mount also include one or more mounting brackets, and each mounting bracket may include a flange that is configured to engage the mounting lip to support the tray proximate the underside of the countertop.

In some installation applications, each mounting bracket may further be secured to an associated adjustable rail that includes first and second opposing ends that are respectively configured to be secured to first and second opposing support structures of a base cabinet that supports the countertop, and each adjustable rail may have an adjustable length to position the first and second opposing ends thereof proximate the first and second opposing support structures, and thereby accommodate base cabinets having varying internal dimensions. In addition, in some embodiments, one or more of the mounting brackets may be used independently from any associated adjustable rail, and instead be mounted directly to a supporting structure of the base cabinet, thereby accommodating a wider range of base cabinets of varying internal dimensions.

The various components in an adjustable undercounter mount, in some embodiments, may be provided as part of an overall undercounter wireless power system, while in other embodiments, one or more of such components may be provided separate from other components of a wireless power system. For example, in some embodiments, a tray may be provided as part of an assembly that includes a wireless power transmitter, and one or more mounting brackets and/or adjustable rails may be provided as separate components, e.g., in the form of a mounting kit, that may then be used to support the tray and wireless power transmitter underneath a countertop. Particularly given then wide range of base cabinet widths that are available, it may be desirable, for example, to offer multiple adjustable rail options to cover different ranges of lengths, thereby avoiding the need for a single adjustable rail design to accommodate the full range of base cabinet widths. By doing so, a consumer, for example, may need to purchase only the appropriate adjustable rail component for a given installation application. In addition, while it may be desirable to offer different mounting bracket sizes in some embodiments, in other embodiments, a single size mounting bracket may be used for all installation applications. In addition, while mounting brackets and adjustable rails may be sold separately in some embodiments, it may be desirable in other embodiments to offer a kit that includes one or more (e.g., two) mounting brackets and one or more (e.g., two) adjustable rails that are suitable for a particular installation application.

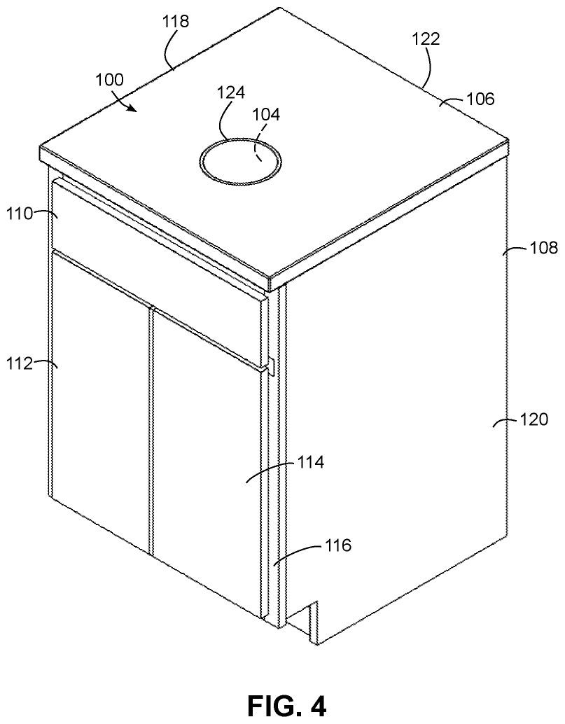

FIGS. 4-8, for example, illustrate one embodiment of an undercounter wireless power system 100 incorporating an adjustable undercounter mount 102 configured to support a wireless power transmitter 104 underneath a countertop 106 supported by a base cabinet 108. As illustrated in FIG. 4, base cabinet 108 may include a drawer 110 and one or more doors 112, 114 on a front face or side 116 thereof, although other configurations (e.g., different numbers and/or configurations of drawers and/or doors) may be used in other embodiments. As illustrated in FIG. 4, base cabinet 108 also includes a left side or wall 118, right side or wall 120 and rear side or wall 122. In addition, as noted above, as wireless power system 100 is installed in an undercounter fashion, it may also be desirable in some embodiments to include some form of indicator 124 to guide a user as to proper placement of a wirelessly powered appliance to receive power from wireless power system 100.

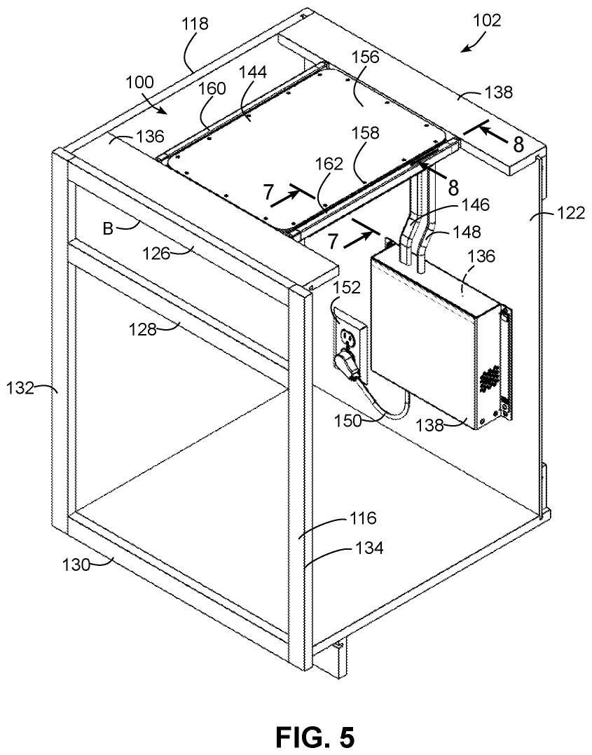

FIG. 5 illustrates base cabinet 108 with the countertop, drawer, doors, and left side removed. As seen in this figure, front face 116 may be defined by horizontally-extending top, middle and bottom stiles 126, 128, 130 and vertically-extending rails 132, 134, with drawer 110 projecting through the opening defined by top and middle stiles 126, 128 and rails 132, 134, and with doors 112, 114 providing access to the interior of the base cabinet through an opening defined by middle and bottom stiles 128, 130 and rails 132, 134. A pair of stretchers 136, 138 extend between the left and right sides 118, 120 proximate the front and rear sides 116, 122, respectively, to provide additional structural support for the base cabinet, and to provide surfaces for supporting and mounting a countertop on the base cabinet. It will be appreciated that various additional structural features, e.g., a toe kick, floor, shelves, nailer strips, etc., may also be provided on base cabinet 108, but are not discussed in further detail herein.

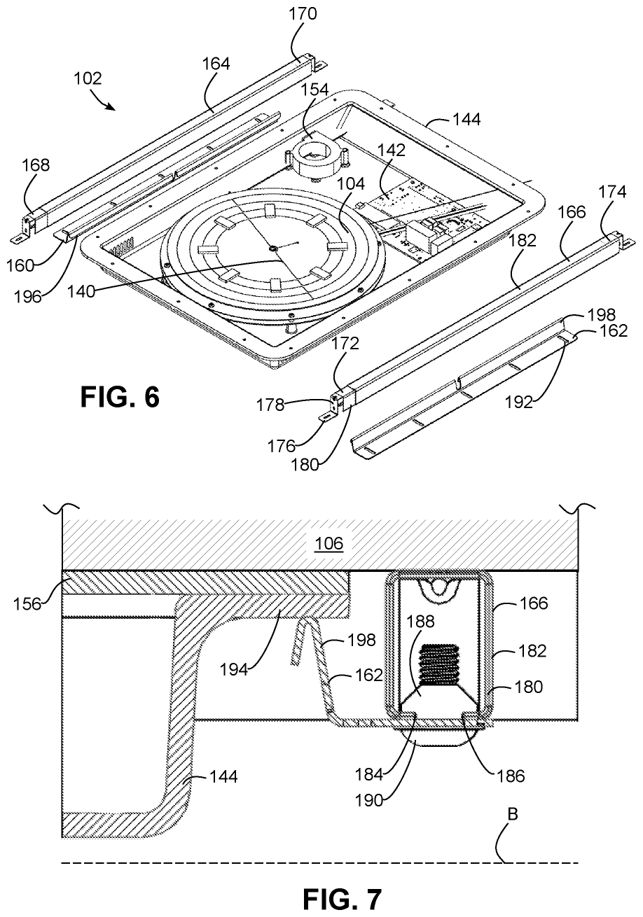

In the illustrated embodiment, undercounter wireless power system 100 utilizes a primarily two-part construction, where a power supply 136 and other higher power electronics are disposed in a power electronics enclosure 138 mounted within the interior of the base cabinet, e.g., on rear side or wall 122, while one or more transmitters, e.g., a wireless power transmitter 104 and an NFC antenna 140, as well as a controller 142, are mounted within a tray 144 (see FIG. 6) positioned proximate an underside of countertop 106, and thus physically separated from the power electronics enclosure. One or more power cables 146 extend from power electronics enclosure 138 to tray 144 to supply power to the various components in the tray, e.g., to provide a power signal for driving wireless power transmitter 104, and one or more control cables 148 extend between enclosure 138 and tray 144 to communicate control signals therebetween, e.g., to enable controller 142 to control the power supply to selectively supply power to a wirelessly powered device through the wireless power transmitter. Line power is supplied to power electronics enclosure 138 by a power cord 150, which may be plugged into a wall outlet 152, or alternatively, hard wired into a residential power circuit. Additional components, e.g., one or more cooling fans 154, may also be disposed in tray 144 and/or power electronics enclosure 138 in some embodiments. In addition, it will be appreciated that the allocation of components to tray 144 and enclosure 138 may vary in other embodiments, that additional enclosures may be used in some embodiments, and that all of the components of the wireless power system may be incorporated into tray 144 in some embodiments.

Tray 144, in some embodiments, forms a portion of adjustable undercounter mount 102 that, when supported proximate an underside of a countertop supported by a base cabinet, in turns supports wireless power transmitter 104 proximate the underside of the countertop and in a position suitable for inductively coupling with and wirelessly powering a wirelessly powered appliance on the countertop. As such, it will be appreciated that tray 144 is configured to position both wireless power transmitter 104 and NFC antenna 140 proximate an underside of countertop 106, thereby enabling wireless power to be supplied to a wirelessly powered appliance positioned on the countertop from wireless power transmitter 104, and to enable controller 142 to communicate with the wirelessly powered device using the NFC antenna 140.

While in some embodiments, tray 144 may be physically separated from the underside of countertop 106, in the illustrated embodiment, adjustable undercounter mount 102 is configured to press or clamp tray 144 against the underside of countertop 106, and to do so in a manner that omits any direct fastening of the tray, and in some instances, all of the other components of the adjustable undercounter mount, to the countertop (e.g., via various adhesives and/or various mechanical fasteners such as screws or bolts). Doing so may simplify retrofit installations where the countertop is already installed on the base cabinet, as well as new installations where the countertop has yet to be installed on the base cabinet. Further, doing so may facilitate adjusting the position of the wireless power transmitter during and/or after installation if so desired.

In some embodiments, tray 144 may be upwardly-open to minimize the physical separation between the wireless power transmitter and the underside of the countertop. In other embodiments, however, and as illustrated in FIG. 5, tray 144 may also include a cover 156 secured thereto using one or more fasteners 158, or via other manners such as tabs or a sliding engagement.

In addition, as illustrated in FIG. 7, it may also be desirable in some embodiments to minimize the depth of tray 144 and/or the other components of adjustable undercounter mount 102, i.e., the distance that the tray and/or other components of the adjustable undercounter mount extend below countertop 106, and thereby minimize the degree to which the these components project into the interior space of the base cabinet that is principally used for storage. It will be appreciated, in particular, that many base cabinets include a drawer positioned directly under the countertop, and as such, any structures that project downwardly in the direction of the drawer may undesirably interact with items stored in the drawer, and may potentially block the drawer from fully opening and/or cause items to fall out of the rear side of the drawer when the drawer is opened. In this regard, it may be desirable in some embodiments for tray 144 and/or the other components of adjustable undercounter mount 102 to not project below a bottom edge B of top stile 126 (or any structure that effectively defines the top edge of the opening for the drawer in the base cabinet) such that no component of the adjustable undercounter mount presents more of an impediment to opening of the drawer than the dimensions of the drawer opening itself.

In the illustrated embodiment, and with specific reference to FIG. 6, adjustable undercounter mount 102 additionally includes a pair of mounting brackets 160, 162 and a pair of adjustable rails 164, 166. Each mounting bracket 160, 162 has a generally L-shaped construction, and in some embodiments may have a length that is similar to a shorter horizontal dimension of tray 144, e.g., a width or left-to-right direction when tray 144 is mounted in the orientation illustrated in FIG. 5. By doing so, each mounting bracket is suitable for mounting along any of the horizontal sides of tray 144.

Each adjustable rail 164, 166 includes respective opposing ends 168, 170, 172, 174, and has an adjustable length enabling its opposing ends to be positioned proximate opposing support structures of the base cabinet for mounting thereto. Each end may include one or more couplers, e.g., various tabs, brackets or other mounting points suitable for securing the adjustable rail to a base cabinet support structure, e.g., the vertical and horizontal couplers 176, 178 illustrated for end 172 of adjustable rail 166. It may be desirable in some embodiments to provide multiple couplers in multiple orientations to accommodate different support structures that may be present in a base cabinet, as well as different surfaces on those support structures. Couplers 176, 178, for example would enable adjustable rail 166 to be secured to a bottom or side surface of a base cabinet stretcher, e.g., using screws that project through apertures formed in the couplers. It will be appreciated, however, that a multitude of other coupler configurations may be used in other embodiments, so the invention is not limited to the particular coupler designs described herein.

While other constructions may be used in other embodiments, each adjustable rail 164, 166 in the illustrated embodiment utilizes a pair of rail members (e.g., rail members 180, 182 for adjustable rail 166), with one of the rail members (e.g., rail member 180) sized and configured to slide within the other rail member (e.g., rail member 182) to adjust the overall length of the adjustable rail. Furthermore, as illustrated in FIG. 7, each rail member 180, 182 is generally U-shaped in cross-section and includes a respective downwardly-facing slot 184, 186, such that one or more fasteners, e.g., one or more nut and bolt assemblies such as nut 188 and bolt 190 illustrated in FIG. 7, may be used to fix the length of the adjustable rail.

As also illustrated in FIG. 7, each mounting bracket 160, 162 and associated adjustable rail 164, 166 may be secured together using the same fasteners used to fix the length of each adjustable rail. In particular, each mounting bracket 160, 162 may include one or more apertures or slots 192 (illustrated in FIG. 6) through which one or more fasteners (e.g., one or more bolts such as bolt 190) may project, such that tightening of the respective nuts and bolts may both secure the mounting bracket to the adjustable rail and fix the length of the adjustable rail. In other embodiments, however, different manners of securing the mounting brackets to the adjustable rails and/or fixing the lengths of the adjustable rails may be used, e.g., separate fasteners for securing the mounting brackets to the adjustable rails and for fixing the length of the adjustable rails. In other embodiments, the mounting brackets may be permanently secured to the adjustable rails (e.g., by being integrally formed, welded together, etc.) It will also be appreciated that other fasteners and/or fastening arrangements, e.g., screws, tabs, etc., may also be used in other embodiments.

As noted above, each mounting bracket 160, 162 may be configured to support tray 144 proximate the underside of countertop 106. In the illustrated embodiment, for example, tray 144 may include a mounting lip 194 disposed proximate a periphery thereof, and each mounting bracket 160, 162 includes a flange 196, 198 that engages mounting lip 194 to support tray 144. Mounting lip 194 in the illustrated embodiment extends about the periphery of tray 144 and includes portions that extend respectively toward each of the left, right, front, and rear sides thereof. By providing a mounting lip that extends fully around tray 144, a mounting bracket may be positioned adjacent any side of the tray as need to support the tray on the underside of the countertop. In other embodiments, however, mounting lip 194 may be discontinuous and/or extend only partly around the periphery of the tray, so the invention is not limited to the particular mounting lip configuration illustrated herein.

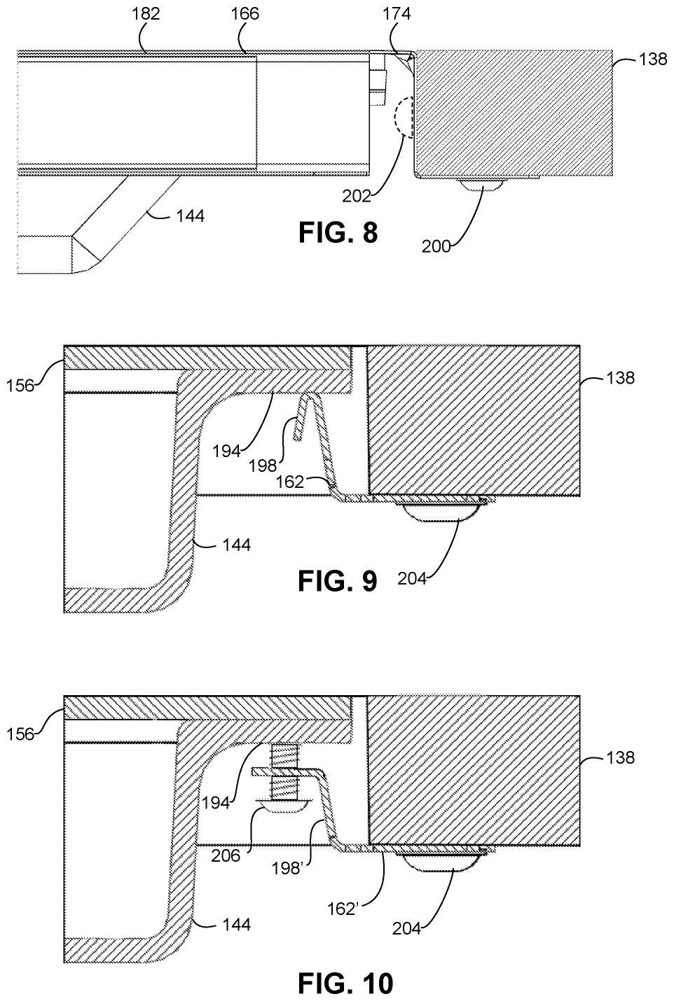

Returning to FIG. 5, one manner of mounting tray 144 to base cabinet 108 may utilize a front-to-rear mounting configuration whereby adjustable rails 164, 166 extend between front and rear sides 116, 122 of base cabinet 108 on opposite sides of tray 144, and are each secured to supporting structures (here stretchers 136, 138) proximate the front and rear sides of the base cabinet, e.g., using one or more screws such as screw 200 screwed into the bottom surface of stretcher 138 as shown in FIG. 8, or alternatively, a screw 202 screwed into a side surface of stretcher 138. Mounting brackets 160, 162 are likewise secured to adjustable rails 164, 166 with the flanges 196, 198 engaging left and right portions of mounting lip 194 that respectively face left and right sides 118, 120 of base cabinet 108. It will be appreciated that in this configuration, the lengths of adjustable rails 164, 166 may be adjusted to accommodate the separation between stretchers 136, 138, while the left-to-right positioning of tray 144, and thus wireless power transmitter 104, may be controlled via the lateral position at which each adjustable rail 164, 166 is secured on the stretchers 136, 138. In addition, given the arrangement of slots 184, 186 and the apertures 192 of mounting brackets 160, 162, front-to-rear positioning of the tray and wireless power transmitter may also be set. Furthermore, where apertures 192 are configured as slots as illustrated in FIG. 6, additional adjustments of the relative placement of flanges 196, 198 relative to mounting lip 194 may also be made to ensure tray 144 is securely supported.

It will be appreciated, however, that the flexible nature of adjustable undercounter mount 102 supports a wide variety of alternate mounting configurations for different installation applications. For example, as illustrated in FIG. 9, in some installations, it may be desirable to omit the use of adjustable rails 164, 166 and instead independently mount a mounting bracket (e.g., mounting bracket 162) directly to a supporting structure of the base cabinet (e.g., stretcher 138, and using one or more screws 204) to support tray 144 underneath countertop 106. While not illustrated in FIG. 9, in some embodiments, mounting bracket 160 may be similarly mounted to stretcher 136. As further illustrated by this example, tray 144 is mounted to base cabinet 108 in a left-to-right mounting configuration, such that front and rear portions of mounting lip 194 are supported by flanges 196, 198 of mounting brackets 160, 162 rather than the left and right portions of mounting lip 194 as is the case with a front-to-rear mounting configuration such as illustrated in FIGS. 6-8.

In addition, with reference to FIG. 7, it will be appreciated that each flange 196, 198 may be formed as a resilient flange (e.g., where each mounting bracket is formed from galvanized steel or another metallic material) to apply a clamping or contact force to mounting lip 194 when tray 144 is pressed or clamped against the underside of countertop 106. The provision of a resilient flange may also be used to accommodate depth variations in different installations, such that a suitable clamping or contact force is applied to the mounting lip over a range of vertical positions relative to the underside of the countertop.

In other embodiments, however, other manners of applying a contact force that presses or clamps tray 144 to the underside of countertop 106 may be used. FIG. 10, for example, illustrates an alternate mounting bracket 162′ with a flange 198′ that, rather than directly contacting mounting lip 194, instead engages the mounting lip through one or more set screws 206 that may be adjusted to control the contact force applied to the tray against the underside of countertop 106. Other variations will be appreciated by those of ordinary skill having the benefit of the instant disclosure.

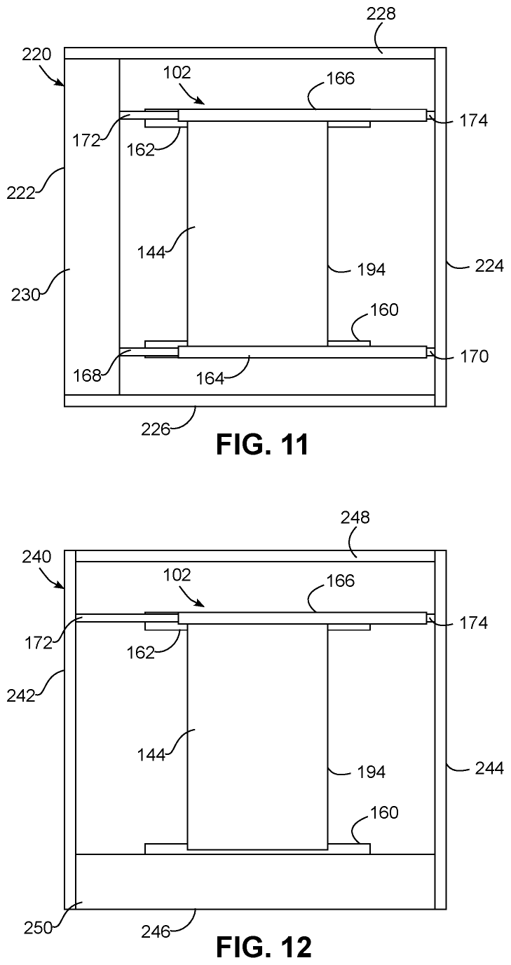

With reference to FIGS. 11 and 12, it will also be appreciated that still other alternate mounting configurations may be supported for different installation applications. FIG. 11, for example, illustrates a base cabinet 220 including left, right, front, and rear sides or walls 222, 224, 226, 228, and constructed with a single stretcher 230 on the left side thereof. In this configuration, tray 144 is supported in base cabinet 220 using a left-to-right mounting configuration, with mounting brackets 160, 162 secured to adjustable rails 164, 166 and positioned to support tray 144 along the front and rear portions of mounting lip 194. The supporting structure to which ends 168, 172 of adjustable rails 164, 166 are secured to base cabinet 220 is stretcher 230, while ends 170, 174 of adjustable rails 164, 166 are secured directly to right wall 224 such that right wall 224 serves as the supporting structure to which ends 170, 174 are secured. It will also be appreciated that left-to-right positioning of tray 144 may be accommodated based upon the positioning of mounting brackets 160, 162 relative to adjustable rails 164, 166, while front-to-rear positioning may be accommodated based upon where adjustable rails 164, 166 are secured relative to the front of the base cabinet.

FIG. 12, as another example, illustrates a base cabinet 240 including left, right, front, and rear sides or walls 242, 244, 246, 248, and constructed with a single stretcher 250 on the front side thereof. In this configuration, tray 144 is also supported in base cabinet 240 using a left-to-right mounting configuration, but rather than using both adjustable rails 164, 166 as is the case with the mounting configuration illustrated in FIG. 11, adjustable rail 164 is omitted, and mounting bracket 160 is secured directly to stretcher 250 of base cabinet 240. Moreover, for adjustable rail 166, end 172 is secured to left wall 242 of base cabinet 240 and end 174 is secured to right wall 244 of base cabinet 244, such that walls 242, 244 serve as the supporting structure to which ends 172, 174 are secured.

In operation, adjustable undercounter mount 102 may be installed prior to countertop installation on a base cabinet, e.g., during cabinet installation in new construction or kitchen remodeling, or after a countertop has been installed on a base cabinet, e.g., for retrofit applications. In either case, installation generally includes an initial analysis of the supporting structures provided in the base cabinet and the overall dimensions thereof and the desired position of the wireless power transmitter. Based upon this analysis, a front-to-rear or left-to-right mounting configuration may be selected, and a determination may be made as to whether both, one, or none of the adjustable rails is to be used. In addition, where multiple lengths of adjustable rails are available, selection of suitably-sized adjustable rails may also be made at this time. Based on the aforementioned determination, any mounting bracket to be used with an adjustable rail is secured thereto in the manner described above. The length(s) of the adjustable rail(s) to be used may then be set to position the ends of the adjustable rail(s) proximate appropriate supporting structures in the base cabinet, and the ends may then be secured to the supporting structures. For any mounting bracket used independently of an adjustable rail, that mounting bracket may also be secured to a supporting structure of the base cabinet at this time. It will be appreciated that any fasteners used to secure the mounting brackets to the adjustable rails or base cabinet may not be fully tightened until the tray is appropriately positioned to allow for adjustments.

In addition, depending upon whether the countertop is already in place, the tray may either be positioned with its mounting lip supported by the flanges of the mounting brackets after all of the mounting brackets and adjustable rail(s) are in place (as may be the case prior to installation of a countertop), or may be positioned prior to mounting all of the mounting brackets and adjustable rail(s). In some instances, for example, it may be desirable to mount one mounting bracket to provide a support for one side of the tray, and then mount the other mounting bracket while the tray is proximate its final position such that opposing sides of the tray are then supported. In other embodiments, however, apertures 192 of mounting brackets 160, 162 may be dimensioned sufficiently such that the mounting brackets may be separated from one another after initial mounting to enable tray 144 to be positioned against the underside of the countertop, and then the mounting brackets may be slid into place and tightened to the support structure and/or adjustable rail to support opposing sides of the tray.

It will be appreciated that, while certain features may be discussed herein in connection with certain embodiments and/or in connection with certain figures, unless expressly stated to the contrary, such features generally may be incorporated into any of the embodiments discussed and illustrated herein. Moreover, features that are disclosed as being combined in some embodiments may generally be implemented separately in other embodiments, and features that are disclosed as being implemented separately in some embodiments may be combined in other embodiments, so the fact that a particular feature is discussed in the context of one embodiment but not another should not be construed as an admission that those two embodiments are mutually exclusive of one another. Various additional modifications may be made to the illustrated embodiments consistent with the invention. Therefore, the invention lies in the claims hereinafter appended.

What is claimed is:

1. An undercounter wireless power system, comprising:
a wireless power transmitter;
a tray housing the wireless power transmitter; and
an adjustable rail configured to support the tray proximate an underside of a countertop supported by a base cabinet, the adjustable rail including first and second opposing ends respectively configured to be secured to first and second opposing support structures of the base cabinet, the adjustable rail having an adjustable length to position the first and second opposing ends thereof proximate the first and second opposing support structures.

2. The undercounter wireless power system of claim 1, wherein the adjustable rail is configured to extend between a front side and a rear side of the base cabinet to support the tray proximate the underside of the countertop through a front-to-rear mounting to the base cabinet.

3. The undercounter wireless power system of claim 1, wherein the adjustable rail is configured to extend between a left side and a right side of the base cabinet to support the tray proximate the underside of the countertop through a left-to-right mounting to the base cabinet.

4. The undercounter wireless power system of claim 1, wherein the adjustable rail is configured to support the tray at an adjustable position between the first and second opposing support structures.

5. The undercounter wireless power system of claim 1, wherein the adjustable rail is configured to support the tray proximate the underside of the countertop with no direct fastening of the tray or the adjustable rail to the countertop.

6. The undercounter wireless power system of claim 1, wherein the adjustable rail is a first adjustable rail, and the undercounter wireless power system further includes a second adjustable rail configured to support the tray proximate an opposite side of the tray from the first adjustable rail, the second adjustable rail including first and second opposing ends respectively configured to be secured to the first and second opposing support structures of the base cabinet, and the second adjustable rail having an adjustable length to position the first and second opposing ends thereof proximate the first and second opposing support structures.

7. The undercounter wireless power system of claim 1, further comprising a mounting bracket secured to the adjustable rail, wherein the adjustable rail supports the tray using the mounting bracket.

8. The undercounter wireless power system of claim 7, wherein the tray includes a mounting lip disposed proximate a periphery thereof, and the mounting bracket includes a flange that engages the mounting lip of the tray.

9. The undercounter wireless power system of claim 8, wherein the flange is resilient to clamp the tray against the underside of the countertop.

10. The undercounter wireless power system of claim 8, wherein the mounting bracket includes one or more set screws extending through the flange of the mounting bracket to such that the flange engages the mounting lip of the tray through the one or more set screws to thereby clamp the tray against the underside of the countertop.

11. The undercounter wireless power system of claim 8, wherein the mounting lip includes left, right, front, and rear portions respectively configured to extend toward left, right, front, and rear sides of the base cabinet, wherein the flange of the mounting bracket is configured to engage the mounting lip of the tray at any one of the left, right, front, and rear portions thereof to support both left-to-right and front-to-rear mounting to the base cabinet.

12. The undercounter wireless power system of claim 7, wherein the mounting bracket is removably secured to the adjustable rail and is configured to be independently secured to a support structure of a different base cabinet when separated from the adjustable rail.

13. The undercounter wireless power system of claim 12, wherein the adjustable rail includes first and second rail members, the first rail member is sized and configured to slide within the second rail member, at least one of the first and second rail members includes a slot extending along at least a portion of the length thereof, and the mounting bracket is removably secured to the adjustable rail using at least one nut and bolt assembly that extends through the slot to fix the length of the adjustable rail.

14. The undercounter wireless power system of claim 13, wherein the at least one nut and bolt assembly further extends through the mounting bracket to secure the mounting bracket to the adjustable rail.

15. The undercounter wireless power system of claim 1, further comprising:
a power electronics enclosure physically separated from the tray and configured to be secured to a wall of the base cabinet;
a power supply disposed in the power electronics enclosure and configured to generate a power signal to drive the wireless power transmitter; and
at least one power cable extending between the power electronics enclosure and the tray to communicate the power signal to the wireless power transmitter.

16. The undercounter wireless power system of claim 15, further comprising a near field communication (NFC) antenna and a controller disposed in the tray and electrically coupled to the NFC antenna to communicate with a wirelessly powered device positioned on the countertop proximate the wireless power transmitter, the controller further electrically coupled to the power supply through at least one control cable extending between the tray and the power electronics enclosure to control the power supply to selectively supply power to the wirelessly powered device through the wireless power transmitter.

17. An undercounter wireless power system, comprising:
a wireless power transmitter;
a tray housing the wireless power transmitter, the tray including a mounting lip disposed proximate a periphery thereof; and
a mounting bracket configured to be secured to a support structure of a base cabinet, the mounting bracket including a flange configured to engage the mounting lip of the tray when secured to the support structure of the base cabinet and thereby support the tray proximate an underside of a countertop supported by the base cabinet.

18. The undercounter wireless power system of claim 17, further comprising an adjustable rail removably securable to the mounting bracket and including first and second opposing ends respectively configured to be secured to first and second opposing support structures of the base cabinet, the adjustable rail having an adjustable length to position the first and second opposing ends thereof proximate the first and second opposing support structures.

19. The undercounter wireless power system of claim 17, wherein the mounting lip includes left, right, front, and rear portions respectively configured to extend toward left, right, front, and rear sides of the base cabinet, wherein the flange of the mounting bracket is configured to engage the mounting lip of the tray at any one of the left, right, front, and rear portions thereof to support both left-to-right and front-to-rear mounting to the base cabinet.

20. An adjustable undercounter mount for an undercounter wireless power system of a type including a wireless power transmitter and a tray housing the wireless power transmitter, the adjustable undercounter mount comprising:
a mounting bracket configured to support the tray proximate an underside of a countertop supported by a base cabinet; and
an adjustable rail removably secured to the mounting bracket and including first and second opposing ends respectively configured to be secured to first and second opposing support structures of the base cabinet, the adjustable rail having an adjustable length to position the first and second opposing ends thereof proximate the first and second opposing support structures;
wherein the mounting bracket is configured to be independently secured to a support structure of a different base cabinet when separated from the adjustable rail.
